(19) United States
(12) Patent Application Publication
(10) Pub. No.: US 2026/0095265 A1
(43) Pub. Date: Apr. 2, 2026

(54) MEASURING AND REPORTING PARAMETERS FOR DIFFERENT ANTENNA PORTS

(71) Applicant: Lenovo (United States) Inc., Morrisville, NC (US)

(72) Inventors: Ahmed Hindy, Aurora, IL (US); Vijay Nangia, Woodridge, IL (US)

(73) Assignee: Lenovo (United States) Inc., Morrisville, NC (US)

(21) Appl. No.: 18/903,647

(22) Filed: Oct. 1, 2024

(51) Int. Cl. H04B 17/24; H04B 17/309; H04L 5/00; H04W 24/10

(52) U.S. Cl. CPC H04B 17/24; H04B 17/309; H04L 5/0051; H04W 24/10

(57) ABSTRACT

Various aspects of the present disclosure relate to configuration for joint transmission. An apparatus, such as a UE, may receive a set of multiple reference signals that correspond to multiple subsets of antenna ports of a set of antenna ports. The UE may measure a set of parameters based on the set of multiple reference signals, where the set of parameters may correspond to different subsets of antenna ports of the multiple subsets of antenna ports. The different subsets of antenna ports may be associated with a wireless channel between the UE and a network equipment (NE). The UE may transmit a report that includes feedback information corresponding to the set of parameters. The report may include an indication of a reference signal from the set of reference signals corresponding to the set of parameters.

### TECHNICAL FIELD

The present disclosure relates to wireless communications, and more specifically to parameter measurement (e.g., estimation, detection) and reporting in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive a plurality of reference signals that correspond to a plurality of subsets of antenna ports of a set of antenna ports; measure a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and a NZP network equipment (NE); and transmit a report comprising feedback information corresponding to the set of parameters.

In some implementations of the method and apparatuses described herein, a reference signal of the plurality of reference signals corresponds to a tracking reference signal (TRS). Additionally, or alternatively, a reference signal of the plurality of reference signals corresponds to a channel state information (CSI) reference signal (CSI-RS) that is transmitted via a non-zero power (NZP) CSI-RS resource. Additionally, or alternatively, a reference signal of the plurality of reference signals corresponds to a CSI-RS received via multiple NZP CSI-RS resources over a same slot.

Additionally, or alternatively, a reference signal of the plurality of reference signals corresponds to a CSI-RS received via two NZP CSI-RS resources, wherein each NZP CSI-RS resource is associated with a single port. Additionally, or alternatively, the set of parameters comprises at least one of a pathloss, a wideband channel gain, a reference signal received power (RSRP), a signal-to-interference-and-noise ratio (SINR), a Doppler shift, an average delay, or a large-scale channel parameter. Additionally, or alternatively the plurality of reference signals is quasi-collocated (QCLed) with at least one of a synchronized signal/physical broadcast channel (SS/PBCH), a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a demodulation reference signal (DMRS) associated with at least one of a physical downlink shared channel (PDSCH) or a physical downlink control channel (PDCCH), according to at least one of a Doppler shift, a Doppler spread, an average delay, or a delay spread. Additionally, or alternatively, a subset of reference signals of the plurality of reference signals is QCLed with a sounding reference signal (SRS), a DMRS associated with a physical uplink shared channel (PUCCH), or both according to at least one of a Doppler shift, a Doppler spread, an average delay, or a delay spread, wherein the SRS is associated with a spatial transmit filter.

In some implementations of the method and apparatuses described herein, a UE receives the plurality of reference signals over multiple occasions in a sequence of slots in time, wherein an occasion of the sequence of slots in time corresponds to a distinct group of one or more symbols over at least one slot. In some implementations of the method and apparatuses described herein, the UE measures a subset of the set of parameters for the occasion of the sequence of slots.

In some implementations of the method and apparatuses described herein, to measure the set of parameters, the UE measures one or more parameters for each occasion of the sequence of slots, wherein the feedback information corresponds to the one or more parameters. In some implementations, the feedback information corresponds to at least one parameter for each reference signal of the plurality of reference signals. Additionally, or alternatively, the plurality of reference signals comprises two reference signals, and wherein the report includes a first of two parameter values in a differential form with respect to a value of a second of the two parameter values. Additionally, or alternatively, the report includes an indication of a reference signal from the plurality of reference signals. In some implementations of the method and apparatuses described herein, the report is configured with a periodic time-domain behavior, and to transmit the report, the UE transmits the report via a PUCCH.

Some implementations of the method and apparatuses described herein may further include a processor for wireless communication to receive a plurality of reference signals that correspond to a plurality of subsets of antenna ports of a set of antenna ports; measure a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and an NE; and transmit a report comprising feedback information corresponding to the set of parameters.

In some implementations of the method and apparatuses described herein, a reference signal of the plurality of reference signals corresponds to a TRS. Additionally, or alternatively, a reference signal of the plurality of reference signals corresponds to a CSI-RS that is received via an NZP CSI-RS resource. Additionally, or alternatively, a reference signal of the plurality of reference signals corresponds to a CSI-RS received via multiple NZP CSI-RS resources over a same slot.

Additionally, or alternatively, a reference signal of the plurality of reference signals corresponds to a CSI-RS received via two NZP CSI-RS resources, wherein each NZP CSI-RS resource is associated with a single port. Additionally, or alternatively, the set of parameters comprises at least one of a pathloss, a wideband channel gain, an RSRP, an SINR, a Doppler shift, an average delay, or a large-scale channel parameter. Additionally, or alternatively, the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

In some implementations of the method and apparatuses described herein, a processor is configured to receive the plurality of reference signals over multiple occasions in a sequence of slots in time, wherein an occasion of the sequence of slots in time corresponds to a distinct group of one or more symbols over at least one slot. In some implementations of the method and apparatuses described herein, a processor is configured to measure a subset of the set of parameters for the occasion of the sequence of slots.

In some implementations of the method and apparatuses described herein, to measure the set of parameters, the processor is configured to measure one or more parameters for each occasion of the sequence of slots, wherein the feedback information corresponds to the one or more parameters. In some implementations, the feedback information corresponds to at least one parameter for each reference signal of the plurality of reference signals. Additionally, or alternatively, the plurality of reference signals comprises two reference signals, and wherein the report includes a first of two parameter values in a differential form with respect to a value of a second of the two parameter values. Additionally, or alternatively, the report includes an indication of a reference signal from the plurality of reference signals. In some implementations of the method and apparatuses described herein, the report is configured with a periodic time-domain behavior, and to transmit the report, the processor is configured to transmit the report via a PUCCH.

Some implementations of the method and apparatuses described herein may further include a method performed by a UE, the method including receiving a plurality of reference signals that correspond to a plurality of subsets of antenna ports of a set of antenna ports; measuring a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and an NE; and transmitting a report comprising feedback information corresponding to the set of parameters.

Some implementations of the method and apparatuses described herein may further include an NE for wireless communication to transmit a plurality of reference signals that correspond to a plurality of subsets of antenna ports of a set of antenna ports; and receive a report comprising feedback information corresponding to a set of parameters based at least in part on the plurality of reference signals, wherein the set of parameters corresponds to different subsets of antenna ports of the plurality of subsets of antenna ports, and wherein the different subsets of antenna ports are associated with a wireless channel between a UE and the NE.

In some implementations of the method and apparatuses described herein, a reference signal of the plurality of reference signals corresponds to a TRS. Additionally, or alternatively, a reference signal of the plurality of reference signals corresponds to a CSI-RS that is transmitted via an NZP CSI-RS resource. Additionally, or alternatively, a reference signal of the plurality of reference signals corresponds to a CSI-RS transmitted via multiple NZP CSI-RS resources over a same slot.

Additionally, or alternatively, a reference signal of the plurality of reference signals corresponds to a CSI-RS transmitted via two NZP CSI-RS resources, wherein each NZP CSI-RS resource is associated with a single port. Additionally, or alternatively, the set of parameters comprises at least one of a pathloss, a wideband channel gain, an RSRP, an SINR, a Doppler shift, an average delay, or a large-scale channel parameter. Additionally, or alternatively the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

In some implementations of the method and apparatuses described herein, an NE transmits the plurality of reference signals over multiple occasions in a sequence of slots in time, wherein an occasion of the sequence of slots in time corresponds to a distinct group of one or more symbols over at least one slot.

In some implementations of the method and apparatuses described herein, the feedback information corresponds to the one or more parameters. In some implementations, the feedback information corresponds to at least one parameter for each reference signal of the plurality of reference signals. Additionally, or alternatively, the plurality of reference signals comprises two reference signals, and wherein the report includes a first of two parameter values in a differential form with respect to a value of a second of the two parameter values. Additionally, or alternatively, the report includes an indication of a reference signal from the plurality of reference signals. In some implementations of the method and apparatuses described herein, the report is configured with a periodic time-domain behavior, and to receive the report, the NE receives the report via a PUSCH.

### BRIEF DESCRIPTION OF THE DRAWINGS

FIG. 1 illustrates an example of a wireless communications system in accordance with aspects of the present disclosure.

FIG. 2 illustrates an example of an aperiodic trigger state in accordance with aspects of the present disclosure.

FIG. 3 illustrates an example of an aperiodic trigger state in accordance with aspects of the present disclosure.

FIGS. 4a and 4b illustrate examples of radio resource control (RRC) configurations in accordance with aspects of the present disclosure.

FIG. 5 illustrates an example of a partial CSI omissions in accordance with aspects of the present disclosure.

FIG. 6 illustrates an example of an ASN-1 code in accordance with aspects of the present disclosure.

FIG. 7 illustrates an example of a TRS configuration in accordance with aspects of the present disclosure.

FIG. 8 illustrates an example of an Abstract Syntax Notation-One (ASN-1) code in accordance with aspects of the present disclosure.

FIG. 9 illustrates an example of an ASN-1 code in accordance with aspects of the present disclosure.

FIG. 10 illustrates an example of an ASN-1 code in accordance with aspects of the present disclosure.

FIGS. 11 and 12 illustrate examples of DMRS patterns in accordance with aspects of the present disclosure.

FIG. 13 illustrates an example of a reference signal configuration in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of an NE in accordance with aspects of the present disclosure.

FIGS. 17 and 18 illustrate flowcharts of methods in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Further, in some wireless communications systems (e.g., sixth generation (6G) wireless networks and beyond), extra-large (XL) multiple-input multiple-output (MIMO) network deployment scenarios may become more prevalent, particularly in combination with upper mid-band frequency carriers (e.g., frequency range 3 (FR3)). Spatial non-stationarity may be an issue in XL MIMO networks, for example, as caused by large antenna sizes. Spatial non-stationarity is a variation in parameter values (e.g., large-scale parameter (LSP) values) corresponding to a channel model, the parameters including pathloss, shadow fading, delay, and Doppler characteristics, among others. Due to the large number of antenna ports in XL MIMO, estimating a channel over each antenna port may be challenging, and thus, it may be beneficial to identify local and regional parameter values for different sub-arrays of the XL MIMO antenna array.

In some legacy channel estimation procedures, a UE may be configured to receive K CSI-RS ports that correspond to K RF chains, where K>>1. Since the UE may estimate the channel at each RF chain, the UE may identify a spatial stationarity behavior corresponding to an entire (e.g., XL MIMO) antenna array. However, measuring the channel over the K ports and estimating parameter values over all of the ports may be highly complex. Moreover, CSI feedback is designed assuming common parameter values over different antennas of a MIMO array, which may lead to CSI feedback resolution errors. Alternatively, for TRS-based channel estimation, a UE may be configured to receive one more TRSs (e.g., single port) to estimate a Doppler shift and an average delay of the channel. Different TRSs may be mapped to different antenna sub-arrays. However, even if the UE is configured with multiple TRSs for different sub-arrays, there is no straightforward way to map different TRSs to antenna sub-arrays. Moreover, it is not possible to obtain feedback for any corresponding array gain.

Accordingly, the present disclosure supports techniques for estimating local and regional parameters (e.g., LSPs) for different antenna sub-arrays for an XL MIMO array and capturing spatial non-stationarity across the different antenna sub-arrays. More specifically, the present disclosure supports a reference signal configuration that includes a multi-port downlink reference signal that is sparse in the spatial domain compared with conventional CSI-RSs, which may identify parameter values for different antenna sub-arrays more accurately. Additionally, the present disclosure supports enhanced transmission configuration indicator (TCI) signaling, which may identify possible quasi co-location (QCL) relationships for legacy reference signal types with the multi-port downlink reference signal. Moreover, the present disclosure supports a spatial hopping pattern that enables identification of boundaries of sub-arrays associated with different parameter values. Further, techniques are supported for a reporting parameter values for different antenna sub-arrays using a CSI feedback format that enables the network to optimize spatial resources used for downlink transmission.

By utilizing the described techniques, reduced complexity may be achieved in XL MIMO networks. In addition, the described techniques may improve feedback resolution and resource usage efficiency by enabling reporting of parameter values for different antenna sub-arrays. The described techniques may additionally improve signaling fidelity and throughput and decrease signal latency as parameter values are measured and reported more effectively.

Reference is made herein to communicating data or information, such as signaling reference signals and feedback reports. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

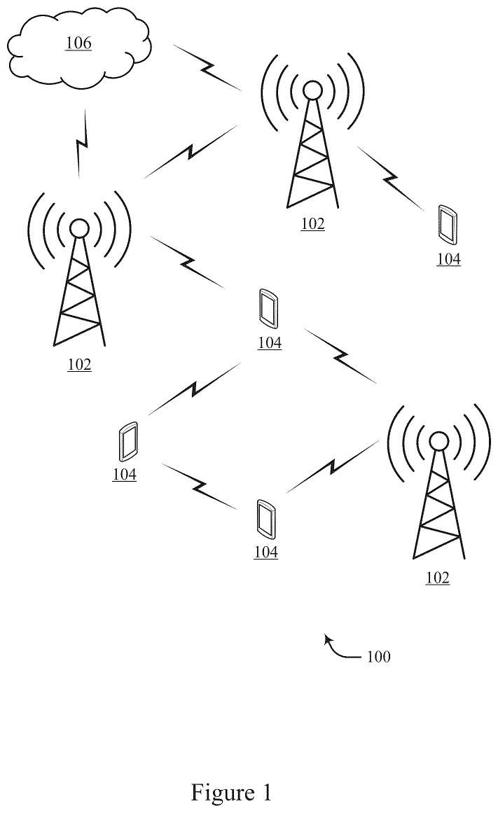

FIG. 1 illustrates an example of a wireless communications system 100 in accordance with aspects of the present disclosure. The wireless communications system 100 may include one or more NEs 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range 1 (FR1) (410 MHz-7.125 GHZ), frequency range 2 (FR2) (24.25 GHz-52.6 GHZ), frequency range 3 (FR3) (7.125 GHz-24.25 GHZ), frequency range 4 (FR4) (52.6 GHZ-114.25 GHZ), frequency range 4a (FR4a) or frequency range 4-1 (FR4-1) (52.6 GHz-71 GHZ), and frequency range 5 (FR5) (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, the NEs 102 and the UEs 104 support estimating local and regional parameters (e.g., LSPs) for different antenna sub-arrays for an XL MIMO array and capturing spatial non-stationarity across the different antenna sub-arrays. More specifically, the present disclosure supports a reference signal configuration that includes a multi-port downlink reference signal that is sparse in the spatial domain compared with conventional CSI-RSs, which may identify parameter values for different antenna sub-arrays more accurately. Additionally, the present disclosure supports enhanced TCI signaling, which may identify possible QCL relationships for legacy reference signal types with the multi-port downlink reference signal. Moreover, the present disclosure supports a spatial hopping pattern that enables identification of boundaries of sub-arrays associated with different parameter values. Further, techniques are supported for a reporting parameter values for different antenna sub-arrays using a CSI feedback format that enables the network to optimize spatial resources used for downlink transmission.

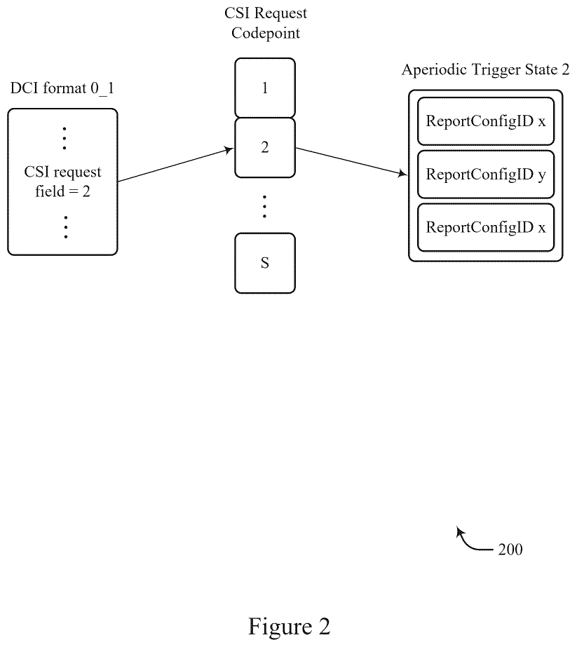

FIG. 2 illustrates an aperiodic trigger state 200 defining a list of CSI report settings. For aperiodic CSI-RS/IM resources and aperiodic CSI reports, triggering may be done jointly by transmission of a DCI Format 0-1. The DCI Format 0_1 may include a CSI request field (0 to 6 bits). A non-zero request field may point to a so-called aperiodic trigger state configured by RRC signaling. An aperiodic trigger state in turn may be defined as a list of up to 16 aperiodic CSI Report Settings, identified by a CSI Report Setting identifier (ID) for which a UE may simultaneously calculate CSI and transmit the CSI on a scheduled PUSCH transmission.

When the CSI report setting is linked with an aperiodic resource setting (which may include multiple resource sets), an aperiodic trigger state definition may also include an aperiodic NZP CSI-RS resource set for channel measurement, an aperiodic CSI-IM resource set (if used), and an aperiodic NZP CSI-RS resource set for IM (if used) to use for a given CSI report setting. For aperiodic NZP CSI-RSs, the aperiodic trigger state definition may also configure a QCL source to use. The UE may assume that it may process the resources used for the computation of the channel and interference with the same spatial filter (e.g., quasi-co-located with respect to “QCL-TypeD”).

For CSI reporting, a codebook report may be partitioned into two parts (e.g., Part 1 and Part 2) based on the priority of information reported. Each part may be encoded separately (where Part 1 may have a higher code rate). An NR Rel. 16 Type-II codebook may include the following parameters (more details can be found in clause 5.2.3-4 of 3GPP TS 38.214): For the content of a CSI report, Part 1 may include a resource index (RI), plus a channel quality indicator (CQI), plus a total quality of coefficients (i.e., RI+CQI+Total number of coefficients), and Part 2 may include an SD basis indicator, plus an FD basis indicator/layer, plus a bitmap/layer, plus coefficient amplitude information/layer, plus coefficient phase information/layer, plus a strongest coefficient indicator/layer (i.e., SD basis indicator+FD basis indicator/layer+Bitmap/layer+Coefficient Amplitude info/layer+Coefficient Phase info/layer+Strongest coefficient indicator/layer).

Furthermore, Part 2 may be decomposed into sub-parts, each with different priority (where higher priority information may be listed first). Such partitioning may be required to allow for a dynamic reporting size for a codebook based on available resources in the uplink phase. More details can be found in clause 5.2.3 of 3GPP TS 38.214).

A type-II codebook may be based on aperiodic CSI reporting and may only be reported via a PUSCH based on DCI triggering (one exception). A type-I codebook may be based on periodic CSI reporting (via a PUCCH) or semi-persistent CSI reporting (via a PUSCH or a PUCCH) or aperiodic reporting (via a PUSCH).

For priority reporting for of Part 2, note that multiple CSI reports may be transmitted with different priorities, as shown in Table 1. A priority of the NRep CSI reports may be based on the following scenarios: (1) A CSI report corresponding to one CSI reporting setting for one cell may have higher priority compared with another CSI report corresponding to one other CSI reporting setting for the same cell; (2) CSI reports associated with one cell may have higher priority compared with other CSI reports associated with another cell; (3) CSI reports may have higher priority based on CSI report content (e.g., CSI reports carrying layer 1 (L1)-RSRP information have higher priority); or (4) CSI reports may have higher priority based on their type. For example, whether the CSI report is aperiodic, semi-persistent or periodic, and whether the report is sent via PUSCH or PUCCH, may impact the priority of the CSI report.

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

In light of these scenarios, CSI reports may be prioritized according to Equation 1, where CSI reports with lower IDs may have higher priority.

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s \qquad ( 1 )$$

In Equation 1, Pri_{iCSI} may represent the order in which the CSI reports are prioritized, s may represent a CSI reporting setting index, Mₛ may represent a maximum number of CSI reporting settings, c may represent a cell index, N_{cells} may represent a number of serving cells, k may have a value of 0 for CSI reports carrying L1-RSRP or L1-SINR, 1 otherwise, and y may have a value of 0 for aperiodic reports, 1 for semi-persistent reports on PUSCH, 2 for semi-persistent reports on PUCCH, or 3 for periodic reports.

For triggering aperiodic CSI reporting on a PUSCH, a UE is to report CSI information for the network using the CSI framework in NR Release 15. The triggering mechanism between a report setting and a resource setting can be summarized in Table 2.

TABLE 2
Triggering mechanism between a report setting and a resource setting

| | | Periodic CSI | | AP CSI |
|---|---|---|---|---|
| | | reporting | SP CSI reporting | Reporting |
| Time Domain | Periodic CSI-RS | RRC configured | MAC CE (PUCCH) | DCI |
| Behaviour of | | | DCI (PUSCH) | |
| Resource Setting | SP CSI-RS | Not Supported | MAC CE (PUCCH) | DCI |
| | | | DCI (PUSCH) | |
| | AP CSI-RS | Not Supported | Not Supported | DCI |

Moreover, all associated resource settings for a CSI report setting may need to have a same time domain behavior, and periodic CSI-RS/IM resources and CSI reports may need to be explicitly triggered or activated. In addition, aperiodic CSI-RS/IM resources and aperiodic CSI reports may be triggered jointly by transmission of a DCI Format 0-1, while semi-persistent CSI-RS/IM resources and semi-persistent CSI reports may be independently activated.

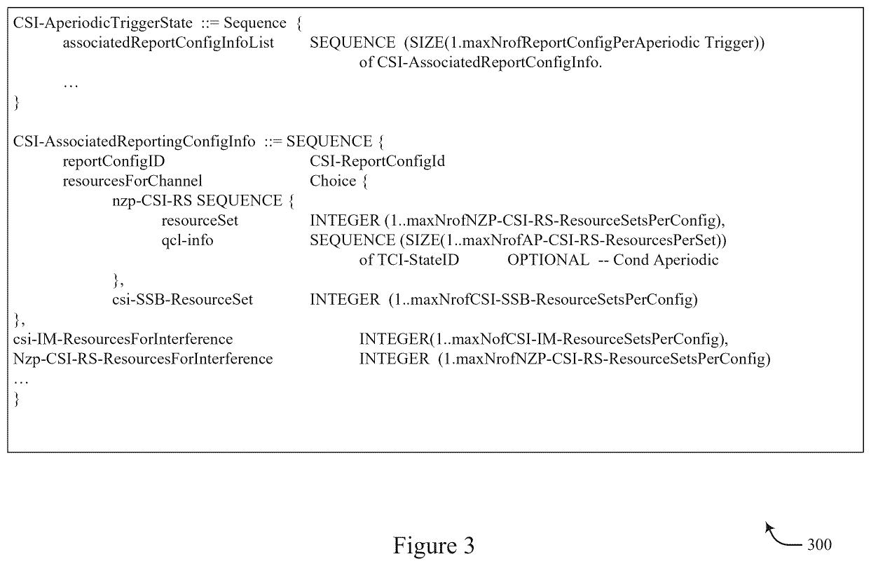

FIG. 3 illustrates an aperiodic trigger state 300 that indicates a resource set and QCL information corresponding to CSI.

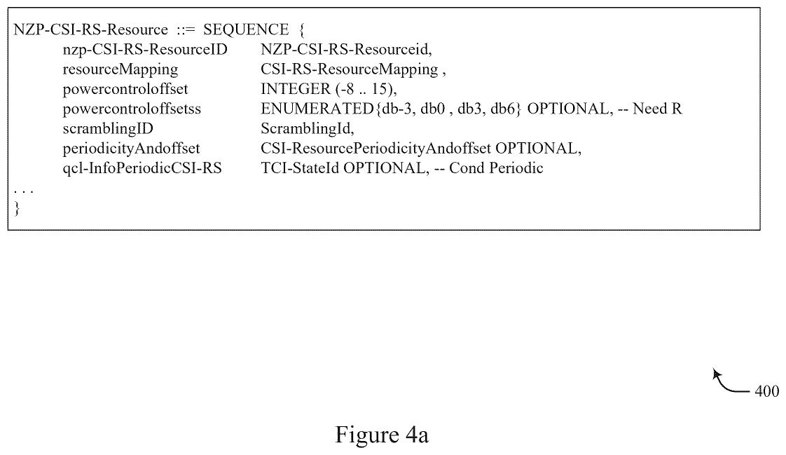

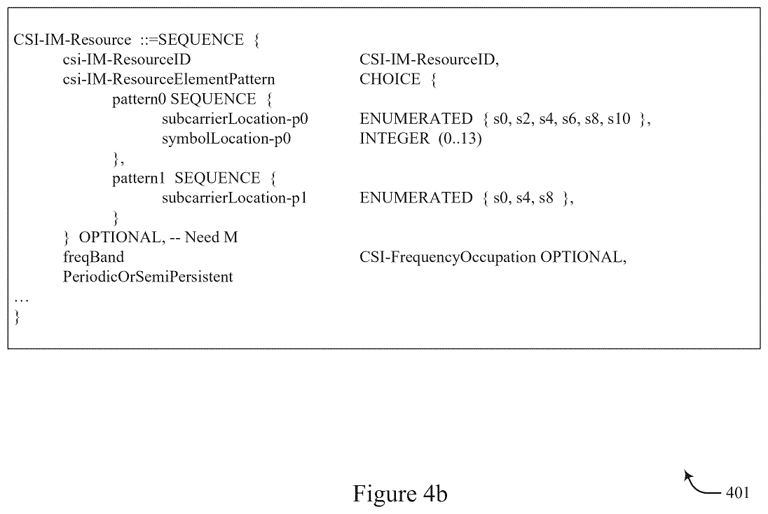

FIGS. 4a and 4b illustrate RRC configurations 400 and 401 for NZP-CSI-RS/CSI-IM resources. For instance, the RRC configuration 400 is an example of an RRC configuration for an NZP-CSI-RS resource, and the RRC configuration 401 is an example of an RRC configuration for a CSI-IM-Resource.

The type of uplink channels used for CSI reporting may be a function of the CSI codebook type, as shown in Table 3.

TABLE 3
Uplink channels used for CSI reporting as a function of the CSI codebook type

| | Periodic CSI reporting | SP CSI reporting | AP CSI reporting |
|---|---|---|---|
| Type I WB | PUCCH Format 2, 3, 4 | PUCCH Format 2 | PUSCH |
| | | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

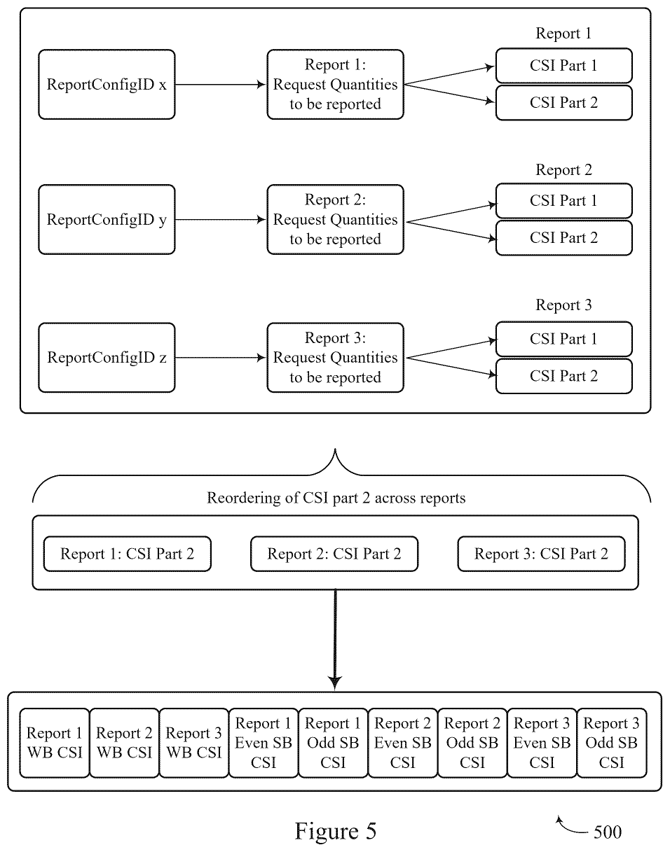

FIG. 5 illustrates a partial CSI omission 500 for PUSCH-based CSI (e.g., Rel. 15 PUSCH-based CSI). For aperiodic CSI reporting, PUSCH-based reports may be divided into two CSI parts: Part 1 (e.g., CSI Part 1) and Part 2 (e.g., CSI Part 2). The reason for this is that the size of CSI payload varies significantly, and therefore a worst-case UCI payload size design may result in large overhead. Part 1 may have a fixed payload size and can be decoded by a gNB without prior information. Part 1 may include an RI (if reported), a CSI resource index (CRI) (if reported) and a CQI for a first codeword, and number of non-zero wideband amplitude coefficients per layer for Type II CSI feedback on PUSCH.

Part 2 may have a variable payload size that may be derived from the CSI parameters in Part 1. In addition, Part 2 may include PMI and a CQI for a second codeword when RI>4. For example, if an aperiodic trigger state indicated by DCI format 0_1 defines three report settings x, y, and z, then the aperiodic CSI reporting for CSI part 2 may be ordered as indicated in FIG. 5.

As described herein, CSI reports may be prioritized according to a time-domain behavior and a type of physical channel, where more dynamic reports may be given precedence over less dynamic reports and PUSCH has precedence over PUCCH; CSI content, where beam reports (e.g., L1-RSRP reporting) may have priority over regular CSI reports; the serving cell to which the CSI corresponds (in case of CA operation); type of cell, where CSI corresponding to the primary cell (PCell) may have priority over CSI corresponding to secondary cells (SCells); or a reportConfigID.

In some examples, a wireless communications system may support a beam management framework and numerous beam management procedures shown in Table 4.

TABLE 4
Beam management procedures

| Process | | |
|---|---|---|
| (P) | Functionality | Description |
| P1 | Beam selection | gNB sweeps TRP beam, and UE sweeps UE beam and |
| | | selects a best one (best TRP beam measured by the best |
| | | UE beam) and reports it to gNB |
| P2 | Beam refinement for | gNB refines beam (e.g., sweeping narrower beam over |
| | transmitter (gNB Tx) | narrower range) and UE detects the best one and reports it |
| | | to gNB |
| P3 | Beam refinement for | gNB fixes a beam (transmits the same beam repeatedly) |
| | received (UE Rx) | and UE refines its receiver beam. UE sets a spatial filter |
| | | on receiver antenna array. This is used only when the UE |
| | | supports beamforming |

For CSI reporting with a report quantity including one of a CRI, SSBRI, L1-RARP, or capability index, the UE may support different processes. For example, if an information element (IE) groupBasedBeamReporting is set to ‘disabled,’ the UE may report K′ values of each report quantity. If groupBasedBeamReporting is set to ‘enabled,’ the UE may report two values of each report quantity for each CSI report setting, where the UE may receive the CSI-RS and the SSB simultaneously by either a same receive spatial filter or multiple simultaneous receive spatial filters. If the UE is configured with an IE groupBasedBeamReporting-r17, the UE may report K groups of two values of each report quantity, with one CRI/SSBRI selected from each of the two CSI resource sets for the report setting. The UE may receive the CSI-RS and the SSB simultaneously.

Moreover, if the UE is configured with the IE groupBasedBeamReporting-v18 set to JointULandDL, the UE may report K groups of two values of each report quantity, with one CRI/SSBRI selected from each of the two CSI resource sets for the report setting. The UE may receive the CSI-RS and SSB simultaneously, and the CSI-RS and the SSB may be applied for simultaneous transmission with receive spatial filters and transmit spatial filters at the UE, respectively, subject to UE capability. If the UE is configured with the IE groupBasedBeamReporting-v18 set to ULOnly, the UE may report K groups of two values of each report quantity, with one CRI/SSBRI selected from each of the two CSI resource sets for the report setting. The UE may apply the CSI-RS and the SSB for simultaneous uplink transmission with a transmit spatial filter at the UE, subject to UE capability. For report quantities including an RSRP, the UE may not be required to update measurements for more than 64 CSI-RS and/or SSB resources. When the UE is configured with a CSI-ReportConfig with the higher layer parameter reportQuantity set to ‘cri-RSRP-Index’ or ‘ssb-Index-RSRP-Index,’ the UE may report an index of UE capability value set, indicating the maximum supported number of SRS antenna ports, along with the pair of SSBRI/CRI and L1-RSRP.

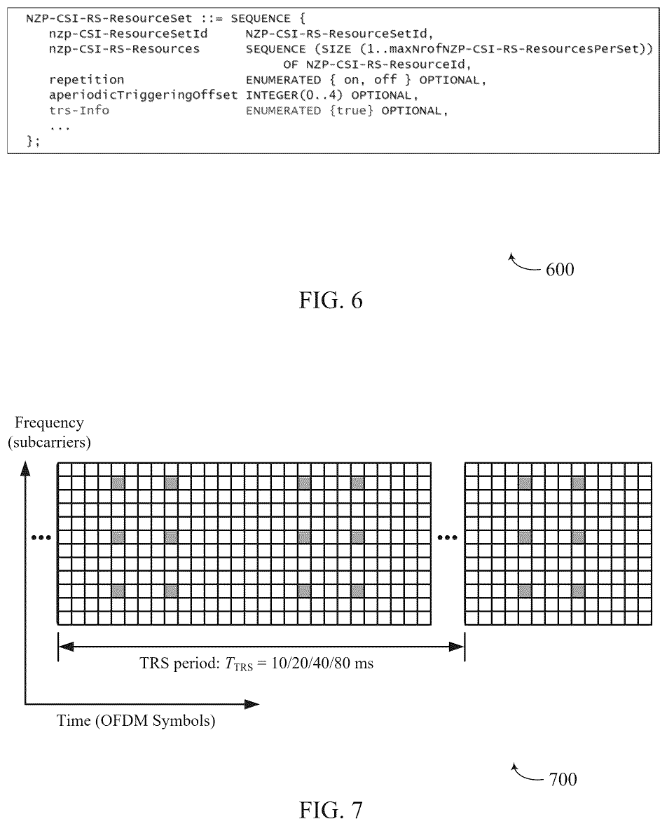

FIG. 6 illustrates an example of an ASN-1 code 600 for configuring an NZP-CSI-RS resource set, as related to multi-resolution precoding based on multiple submatrices in accordance with aspects of the present disclosure. Aspects of multi-resolution precoding based on multiple submatrices include and/or are directed to TRS, which may be transmitted for establishing fine time and frequency synchronization at a UE to aid in demodulation of PDSCH, particularly for higher order modulations. A TRS may be an NZP CSI-RS resource set with “TRS-info” set to true. As shown in the ASN-1 code 600, “trs-info” indicates that the antenna port for all NZP-CSI-RS resources in the CSI-RS resource set may be the same. The TRS may include either 2 or 4 periodic CSI-RS resources with periodicity 2^{-μ}*Xp slots where Xp=10, 20, 40, or 80, where μ is related to the sub carrier spacing (SCS), e.g. μ=0, 1, 2, 3, 4 for 15, 30, 60, 120, 240 kHz, respectively. The slot offsets for the 2 or 4 CSI-RS resources may be configured such that the first pair of resources may be transmitted in one slot, and the second pair (if configured) may be transmitted in the next (adjacent) slot. All four resources may be single port with density 3, as further shown and described herein with reference to FIG. 7.

FIG. 7 illustrates an example of a TRS configuration 700, as related to multi-resolution precoding based on multiple submatrices in accordance with aspects of the present disclosure. In the TRS configuration 700, two CSI-RS within a slot may be separated by four symbols in the time domain. This time-domain separation may set a limit for a maximum frequency error that can be compensated. Likewise, the frequency-domain separation of four subcarriers may set a limit for the maximum timing error that can be compensated. A UE capability may provide the maximum number of TRSs a UE may be configured with. For example, the maximum number of TRS resource sets (per component carrier (CC)) that a UE is able to track simultaneously may be a candidate value set {1 to 8}. Additionally, the maximum number of TRS resource sets configured for the UE per CC may be a candidate value set: {1 to 64}, there the UE may be mandated to report at least 8 for FR1 and 16 for FR2. The maximum number of TRS resource sets configured for the UE across CCs may be a candidate value set: {1 to 256}, where the UE may be mandated to report at least 16 for FR1 and 32 for FR2. Furthermore, an aperiodic TRS may be a set of aperiodic CSI-RS for tracking that is optionally configured, but a periodic TRS needs to be configured, and its time and frequency domain configurations (except for the periodicity) must match those of the periodic TRS. The UE may assume that the aperiodic TRS resources are quasi-co-located with the periodic TRS resources.

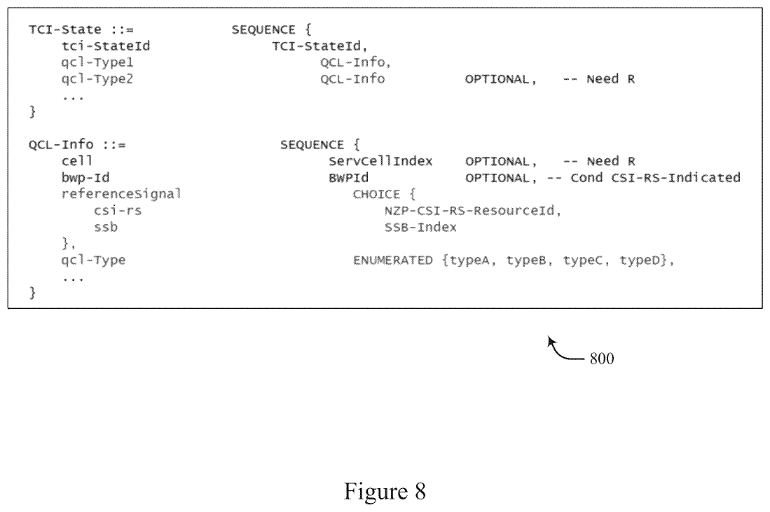

FIG. 8 illustrates an example of an ASN-1 code 800 for QCL information, as related to multi-resolution precoding based on multiple submatrices in accordance with aspects of the present disclosure. In the ASN-1 code 800, a TCI state (as shown in the ASN-1 code 800 and as configured by RRC) may have two QCL types (e.g., two reference signals) with the second QCL type only for operation in FR2.

With reference to DMRS and reception of DMRS for PDSCH, QCL TypeA properties (e.g., Doppler shift, Doppler spread, average delay, delay spread) may be inferred from a periodic TRS. For periodic TRS, QCL TypeC properties (e.g., average delay, Doppler shift) may be inferred from a synchronization signal block (SSB) block. The DMRS may be used to estimate channel coefficients for coherent detection of the physical channels. For downlink, the DMRS may be subject to the same precoding as the PDSCH. NR may first define two time-domain structures for DMRS according to the location of the first DMRS symbol. For example, mapping Type A, where the first DMRS may be located in the second and the third symbols of the slot, and the DMRS may be mapped relative to the start of the slot boundary, regardless of where in the slot the actual data transmission occurs. Further, mapping Type B, where the first DMRS may be positioned in the first symbol of the data allocation, that is, the DMRS location is not given relative to the slot boundary, rather relative to where the data are located.

The mapping of PDSCH transmission may be dynamically signaled as part of the DCI. Moreover, the DMRS has two types, Types 1 and 2, which may be distinguished in frequency-domain mapping and the maximum number of orthogonal reference signals. Type 1 may provide up to four orthogonal signals using a single-symbol DMRS and up to eight orthogonal reference signals using a double-symbol DMRS. For four orthogonal signals, antenna ports 1000 and 1001 use even-numbered subcarriers and may be separated in the code domain within the code-division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and may be generated in the same way using odd-numbered subcarriers. The DMRS Type 2 has a similar structure to Type 1, but Type 2 can provide 6 and 12 patterns depending on the number of symbols. Four subcarriers may be used in each resource block (RB) and in each CDM group defining three CDM groups.

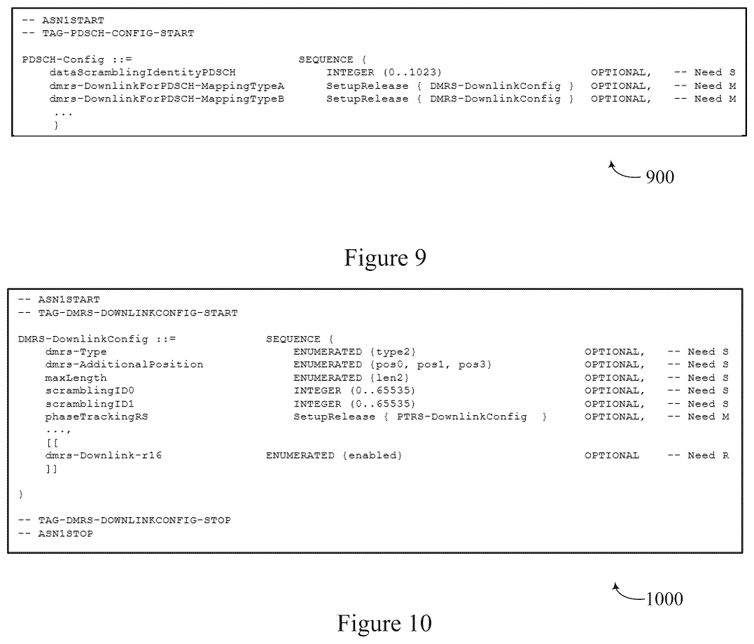

FIG. 9 illustrates an example of an ASN-1 code 900 for a PDSCH-Config in IE, as related to multi-resolution precoding based on multiple submatrices in accordance with aspects of the present disclosure. In the ASN-1 code 900, note that the configuration of the DMRS Type may be provided through higher-layer signaling independently for each PDSCH and PUSCH, each mapping Type (A or B), and each bandwidth part (BWP) independently (see the RRC configuration). The PDSCH-Config IE, as shown in the ASN-1 code 900, may be used to configure UE-specific PDSCH parameters.

FIG. 10 illustrates an example of an ASN-1 code 1000 for a DMRS-DownlinkConfig IE, as related to multi-resolution precoding based on multiple submatrices in accordance with aspects of the present disclosure. In the ASN-1 code 1000, the DMRS-DownlinkConfig IE may be used to configure downlink DMRSs for PDSCH.

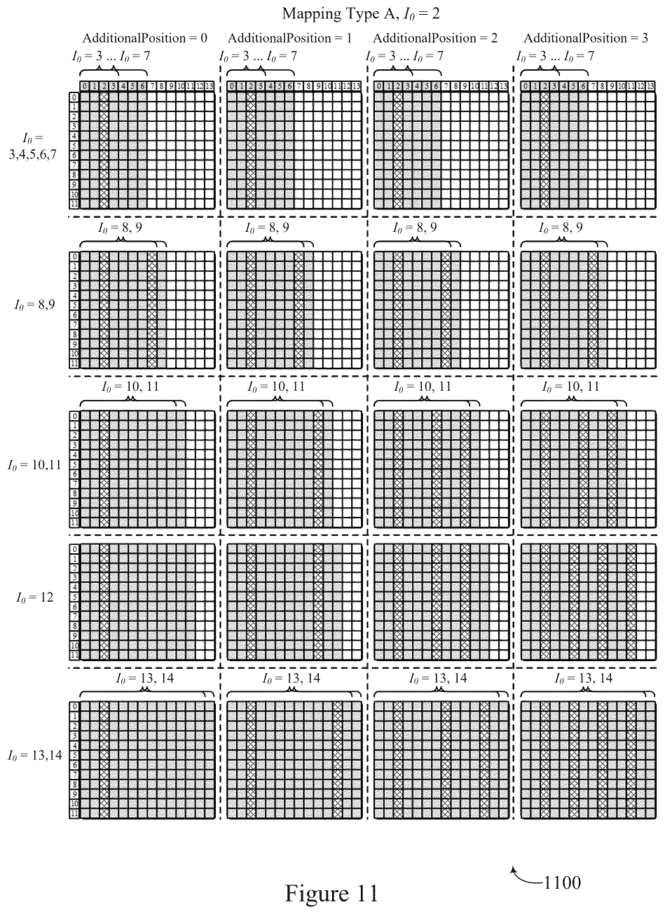

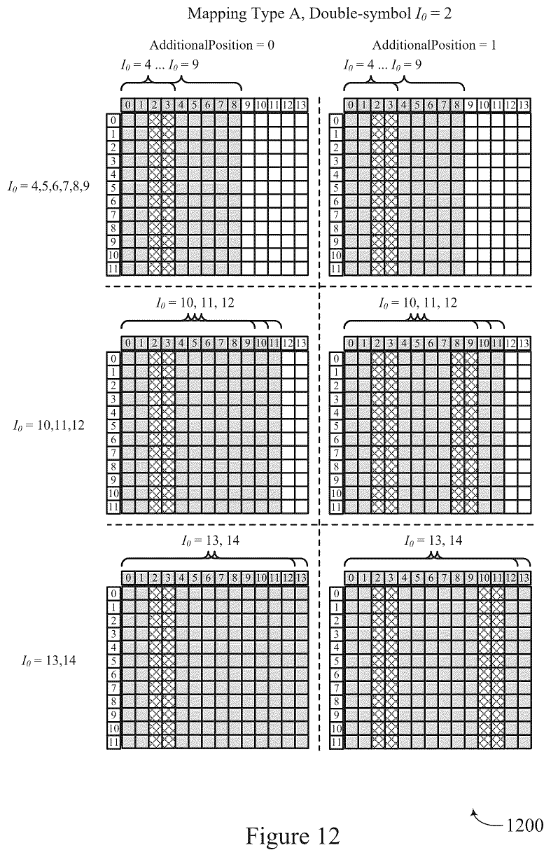

FIGS. 11 and 12 illustrate an example of a DMRS pattern 1100 and a DMRS pattern 1200 for mapping Type A with front-load DMRS, as related to multi-resolution precoding based on multiple submatrices in accordance with aspects of the present disclosure. In some examples of the DMRS pattern 1100 and the DMRS pattern 1200, the time-domain mapping of the DMRS patterns may be decomposed to two parts. For example, a first part may define a DMRS pattern used for the front-load DMRS, and a second part may define a set of additional DMRS symbols inside a scheduled data channel duration which may be either single-symbols, or double-symbols, depending on the length of the front-load DMRS. Inside the scheduled time-domain allocation of a PDSCH, the UE may expect up to 4 DMRS symbols. The location of the DMRS may be defined by both higher-layer configuration and dynamic (DCI-based) signaling, such as dmrs-TypeA-Position, maxLength, and dmrs-AdditionalPosition. When double-symbol DMRS is used, there may be up to one more double-symbol DMRS (total 4 DMRS symbols inside the PDSCH allocation). Different DMRS patterns for mapping Type A with front-load DM-RS are shown in the DMRS pattern 1100 and the DMRS pattern 1200.

In the absence of CSI-RS configuration, and unless otherwise configured, the UE may assume PDSCH DMRS and SS/PBCH block antenna ports are QCLed with respect to Doppler shift, Doppler spread, average delay, delay spread, and spatial relation (Rx) parameters (if applicable). However, a CSI-RS for tracking may be used as a QCL reference (e.g., having larger bandwidth than an SS/PBCH block). Furthermore, the UE may assume that the PDSCH DMRSs within the same CDM group are QCLed with respect to Doppler shift, Doppler spread, average delay, delay spread, and spatial Rx. The UE may then perform a joint estimation of DMRS ports which may be CDMed using the same long-term statistics, and it may not be required to measure, or use, different long-term statistics for different DMRS ports of the same PDSCH.

The following discusses antenna panel/port, QCL, TCI state, and spatial relation. In some implementations, the terms antenna, panel, and antenna panel are used interchangeably. An antenna panel may be a hardware that is used for transmitting and/or receiving radio signals at frequencies lower than 6 GHZ, e.g., FR1, or higher than 6 GHZ, e.g., FR2 or millimeter wave (mmWave). In some implementations, an antenna panel may comprise an array of antenna elements, where each antenna element may be connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it may be used for signaling or local decision making.

In some implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain, which may result in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on the device's own implementation, a “device panel” may have one or more functionalities as an operational role, such as Unit of antenna group to control its transmit beam independently, Unit of antenna group to control its transmission power independently, or Unit of antenna group to control its transmission timing independently. The device panel may be transparent to a network device (e.g., an NE, a gNB). For some conditions, a gNB or a network may assume the mapping between device's physical antennas to the logical entity device panel may not be changed. For example, the condition may remain until a next update or report from a device or may comprise a duration of time over which the gNB may assume there will be no change to the mapping. A device may report its capability with respect to the device panel to the gNB or the network. The device capability may include at least the number of device panels. In one implementation, the device may support uplink transmission from one beam within a panel. If multiple panels are supported, more than one beam may be used for uplink transmission (e.g., one beam per panel). In another implementation, more than one beam per panel may be supported/used for uplink transmission.

In some of the implementations, an antenna port may be defined such that the channel over which a symbol on the antenna port is conveyed may be inferred from the channel over which another symbol on the same antenna port is conveyed.

Two antenna ports are said to be QCLed if the large-scale properties (LSPs) of the channel over which a symbol on one antenna port is conveyed can be inferred from the channel over which a symbol on the other antenna port is conveyed. The large-scale properties may include one or more of delay spread, Doppler spread, Doppler shift, average gain, average delay, and spatial Rx parameters. Two antenna ports may be QCLed with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values: ‘QCL-TypeA’: {Doppler shift, Doppler spread, average delay, delay spread}, ‘QCL-TypeB’: {Doppler shift, Doppler spread}, ‘QCL-TypeC’: {Doppler shift, average delay}, or ‘QCL-TypeD’: {Spatial Rx parameter}.

Spatial Rx parameters may include one or more of angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, and spatial channel correlation, among others.

QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, (e.g., the UE would need to form beams for directional transmission). For a QCL-TypeD between two reference signals A and B, the reference signal A is considered to be spatially co-located with reference signal B and the UE may assume that the reference signals A and B may be received with the same spatial filter (e.g., with the same RX beamforming weights).

An antenna port according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations, a TCI state associated with a target transmission may indicate parameters for configuring a QCL relationship between the target transmission (e.g., target RS of DM-RS ports of the target transmission during a transmission occasion) and a source reference signal(s) (e.g., SSB/CSI-RS/SRS) with respect to QCL type parameter(s) indicated in the corresponding TCI state. The TCI describes which reference signals are used as QCL source, and what QCL properties may be derived from each reference signal. A device may receive a configuration of a plurality of TCI states for a serving cell for transmissions on the serving cell. In some of the implementations, a TCI state may comprise at least one source RS to provide a reference (e.g., a UE assumption) for determining QCL and/or spatial filter.

In some of the implementations, a spatial relation information associated with a target transmission may indicate parameters for configuring a spatial setting between the target transmission and a reference RS (e.g., SSB/CSI-RS/SRS). For example, the device may transmit the target transmission with the same spatial domain filter used for reception the reference RS (e.g., downlink reference signal such as SSB/CSI-RS). In another example, the device may transmit the target transmission with the same spatial domain transmission filter used for the transmission of the reference RS (e.g., uplink reference signal such as SRS). A device can receive a configuration of a plurality of spatial relation information configurations for a serving cell for transmissions on the serving cell.

In some of the implementations, an uplink TCI state may be provided if a device is configured with separate downlink/uplink TCI by RRC signaling. The uplink TCI state may comprise a source reference signal which may provide a reference for determining uplink spatial domain transmission filter for the uplink transmission (e.g., dynamic-grant/configured-grant based PUSCH, dedicated PUCCH resources) in a CC or across a set of configured CCs/BWPs.

In some of the implementations, a joint downlink/uplink TCI state may provided if the device is configured with joint downlink/uplink TCI by RRC signaling (e.g., configuration of joint TCI or separate downlink/uplink TCI is based on RRC signaling). The joint downlink/uplink TCI state may refer to at least a common source reference signal used for determining both the downlink QCL information and the uplink spatial transmission filter. The source reference signal determined from the indicated joint (or common) TCI state provides QCL Type-D indication (e.g., for device-dedicated PDCCH/PDSCH) and is used to determine uplink spatial transmission filter (e.g., for UE-dedicated PUSCH/PUCCH) for a CC or across a set of configured CCs/BWPs. In one example, the uplink spatial transmission filter is derived from the reference signal of downlink QCL Type D in the joint TCI state. The spatial setting of the uplink transmission may be according to the spatial relation with a reference to the source reference signal configured with qcl-Type set to ‘typeD’ in the joint TCI state.

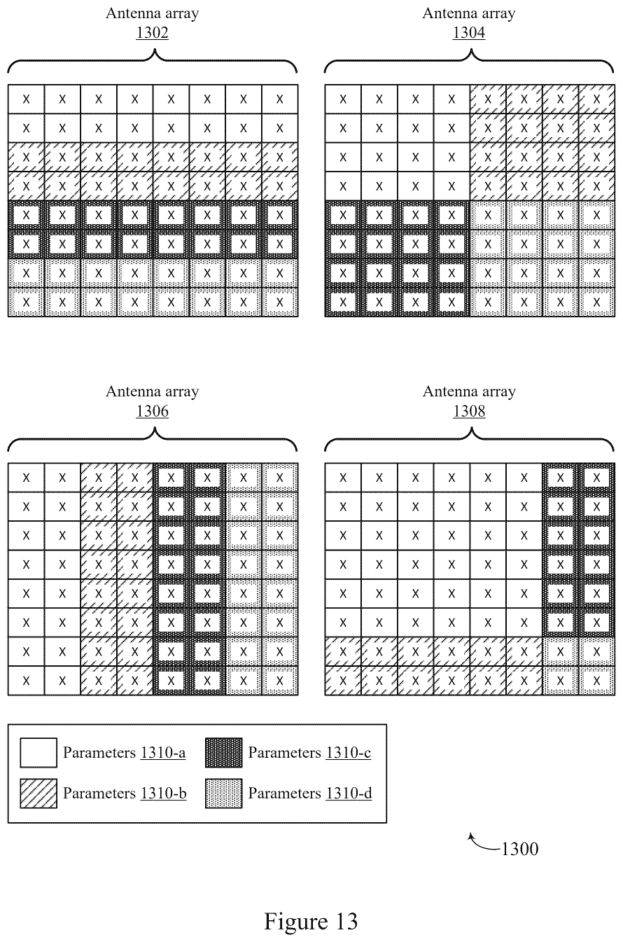

FIG. 13 illustrates examples of reference signal configuration 1300 in accordance with aspects of the present disclosure. The reference signal configuration 1300 may include examples of mappings of resources and/or ports with legacy CSI-RS resources and/or ports varying over different transmission occasions for periodic reference signals, including an antenna array 1302, an antenna array 1304, an antenna array 1306, and an antenna array 1308. As described herein, the reference signal configuration 1300 may enable estimation of local and regional parameter (e.g., LSP) values for different antenna sub-arrays. In addition, the reference signal configuration 1300 may demonstrate spatial non-stationarity across the different antenna sub-array partitions.

As described herein, the terms NE, network node, TRP, panel, set of antennas, set of antenna ports, uniform linear array, cell, node, radio head, communication (e.g., signals/channels) associated with a control resource set (CORESET) pool, and communication associated with a TCI state from a transmission configuration comprising at least two TCI states, may be used interchangeably. Additionally, a subset of antenna ports of an antenna array may also be referred to as an antenna sub-array. In addition, a TRS as described herein may correspond to an NZP CSI-RS resource set with a parameter trs-info being configured, and a CSI-RS may correspond to an NZP CSI-RS resource set with neither of the parameters trs-info nor repetition being configured. Hereafter, a matrix may imply a sequence of fields of an arbitrary dimension, including an array (vector) of values, a standard two-dimensional (2D) matrix, and more generally, a Q-dimensional matrix (e.g., a tensor), where Q≥2 is an integer value. Additionally, a CSI framework or procedure associated with up to 3GPP Rel-18 may be referred to herein as legacy behavior. Several implementations are described below. According to a possible implementation, one or more elements or features from one or more of the implementations described herein with reference to FIG. 13 may be combined.

The reference signal configuration 1300 may support measuring channel parameter values (also referred to as LSP values). In a first phase of the CSI measurement and reporting framework described herein, the reference signal configuration 1300 may support reception of reference signals from different antennas. For example, an NE may configure a UE to receive a set of reference signals (e.g., spatial-domain reference signals) via a downlink. The UE may use the set of reference signals to measure parameter values for different antenna ports corresponding to a wireless channel between the NE-side and the UE-side. One or more elements or features from one or more of the following described implementations may be combined.

In some implementations, each reference signal of the set of reference signals may be associated with a distinct subset of antenna ports of a set of antenna ports associated with the NE. That is, the set of antenna ports may constitute multiple subsets of antenna ports. In some examples, the one or more subsets of antenna ports may include a same number of ports. In some cases, the one or more subsets of antenna ports may have a same dimension. For example, a ratio of a number of antennas over two dimensions may be the same, assuming a rectangular layout of N₁×N₂ antenna array size, where a k^{th} subset of antenna ports may include a layout of

$${N}_{1}^{( k )} \times {N}_{2}^{( k )}$$

antennas, and where a ratio

$${N}_{2}^{( k )} / {N}_{1}^{( k )}$$

may be the same for all k values.

In some examples, the NE may configure a partitioning of the set of antenna ports to the subsets of antenna ports using higher-layer signaling (e.g., via RRC signaling). In other examples, the set of antenna ports may be partitioned into the multiple subsets of antenna ports based on a modified antenna port indexing for each dimension. For example, antenna ports for consecutive IDs over one dimension may be grouped into a same subset of antenna ports. In some examples, each subset of antenna ports may include a single antenna port, and a number of subsets of antenna ports may be ess than a number of antenna ports in the set of antenna ports.

In another implementation, the set of reference signals may include TRSs. That is, the set of reference signals (e.g., SDRSs) may correspond to TRSs received over multiple TRS resource sets. In some examples, each TRS resource set of the multiple TRS resource sets may be associated with reference signals included on only one slot (e.g., each TRS resource set may include two CSI-RS resources. In other examples, the multiple TRS resource sets may be configured with a periodic time-domain behavior. Alternatively, the multiple TRS resource sets may be configured with an aperiodic time-domain behavior. In some cases, the multiple TRS resource sets may be configured with aperiodic time-domain behavior, where one additional periodic TRS may correspond to the set of antenna arrays.

In some implementations, a reference signal may be a CSI-RS. That is, the set of parameters (e.g., SDRSs) may correspond to CSI-RSs received over multiple NZP CSI-RS resources. The multiple NZP CSI-RS resources may be associated with a same NZP CSI-RS resource set. In some cases, the NZP CSI-RS resources may be associated with an NZP CSI-RS resource set that the NE may configure with a higher-layer parameter corresponding to a spatial-domain channel property (SDCP). In some examples, each NZP CSI-RS resource may include a single port.

The NE may configure the multiple NZP CSI-RS with an aperiodic time-domain behavior, where the NE may configure one or more NZP CSI-RS resources (that are not configured with TRS (e.g., trs-info), repetition (e.g., repetition), or SDCP) with one of either periodic time-domain behavior, semi-persistent time-domain behavior, or aperiodic time-domain behavior. Alternatively, the NE may configure the multiple NZP CSI-RS resources with a semi-persistent time-domain behavior, where the NE may configure one more NZP CSI-RS resources (that are not configured with TRS, repetition, or SDCP) with one or semi-persistent time-domain behavior or aperiodic time-domain behavior. Alternatively, the NE may configure the multiple NZP CSI-RS resources with aperiodic time-domain behavior, where the NE may configure one more NZP CSI-RS resources (that are not configured with TRS, repetition, or SDCP) aperiodic time-domain behavior. In some examples, the multiple NZP CSI-RS resources and one or more NZP CSI-RS resources that are not configured with TRS, repetition, or SDCP may be configured with a same time-domain behavior.

In some implementations, the set of reference signals may correspond to CSI-RS ports. That is, the set of reference signals (e.g., SDRSs) may correspond to CSI-RSs received via a set of NZP CSI-RS ports of one or more NZP CSI-RS resources. In some examples, the multiple NZP CSI-RS may be associated with a same NZP CSI-RS resource. The multiple NZP CSI-RS ports may be associated with an NZP CSI-RS resource set that the NE may configure with a higher-layer parameter corresponding to a SDCP. In some examples, the multiple NZP CSI-RS may be partitioned into two groups of NZP CSI-RS ports, where each of the two groups may be associated with a distinct CDM group.

In some implementations, the set of reference signals may correspond to spatial reference signals SpRSs. That is, the set of reference signals (e.g., SDRSs) may correspond to SpRSs received over multiple spatial resource sets. In some examples, each SpRS resource set may include two CSI-RS resources. Each CSI-RS resource may be associated with one port and a density value of two, such that the UE may expect to receive a same reference signal symbol over two resource elements (REs) of a same RB, where the SpRSs occupy same symbol in a given slot. In some examples, each SpRS resource set may be an NZP CSI-RS resource set that the NE may configure with a higher-layer parameter corresponding to an SDCP. In some cases, the multiple SpRS resource sets may be configured with either a periodic time-domain behavior or an aperiodic time-domain behavior.

In some implementations, the UE may measure a set of parameters corresponding to the set of reference signals (e.g., SDRSs). In some examples, the set of reference signals may include one or more of a pathloss, a wideband channel gain, an RSRP (e.g., L1-RSRP), an SINR (e.g., L1-SINR), a Doppler shift, an average delay. The UE may measure a subset of the set of parameters based on a higher-layer configuration, such as a CSI reporting configuration. In some examples, the UE may measure a set of parameters for each reference signal in the set of reference signals.

The reference signal configuration 1300 may support enhanced TCI signaling for parameter (e.g., LSP) channel estimation. In some cases, the set of reference signals described in the first phase may be QCLed with other downlink reference signals, and in some cases, in spatial relation with uplink reference signals, according to a set of configured and reported parameters (e.g., QCL information for the set of reference signals with other downlink reference signals). One or more elements or features from one or more of the following described implementations may be combined.

In an implementation, each reference signal of the set of reference signals (e.g., each SDRS of a set of SDRSs) may be QCLed with a corresponding periodic TRS, at least with respect to Doppler shift and Doppler spread properties. For example, each reference signal may be QCLed with a corresponding periodic TRS according to QCL Type-B.

In another implementation, each reference signal of the set of reference signals may be QCLed with a corresponding SS/PBCH, at least with respect to Doppler shift and Doppler spread properties. For example, each reference signal may be QCLed with a corresponding SS/PBCH according to QCL Type-B.

In another implementation, each reference signal of the set of reference signals may be QCLed with a corresponding CSI-RS resource set for beam management (not based on the reference signal). For example, the reference signal may be QCLed with a corresponding NZP CSI-RS resource set that the NE configured with a higher-layer parameter repetition with respect to Doppler shift and Doppler spread, according to QCL Type-B, and a spatial Rx parameter according to QCL Type-D, if applicable. This may correspond to scenarios in which the NE transmits a CSI-RS for beam management prior to transmitting the reference signal of the set of reference signals.

In another implementation, a subset of reference signals (e.g., SDRSs) of the set of reference signals may be QCLed with a corresponding CSI-RS resource set for beam management (e.g., based on the reference signal). For example, the reference signal may be QCLed with a corresponding NZP CSI-RS resource set that the NE configured with a higher-layer parameter repetition with respect to Doppler shift, Doppler spread, average delay and delay spread according to QCL Type-A, and a spatial Rx parameter according to QCL Type-D, if applicable. This may correspond to scenarios in which the NE transmits a CSI-RS for beam management based on the subset of reference signals.

In another implementation, a subset of reference signals (e.g., SDRSs) of the set of reference signals may be QCLed with a corresponding CSI-RS resource set that may not be associated with a TRS or beam management. For example, the subset of reference signals may be QCLed with an NZP CSI-RS resource set that the NE did not configure with higher-layer parameters repetition or trs-info with respect to Doppler shift, Doppler spread, and average delay and delay spread according to QCL Type-A. This may correspond to scenarios in which the NE transmits a CSI-RS for beam management based on the subset of reference signals (e.g., SDRSs).

In another implementation, a subset of reference signals (e.g., SDRSs) of the set of reference signals may be QCLed with a corresponding DMRS for at least one of PDSCH or PDCCH with respect to Doppler shift, Doppler spread, and average delay and delay spread according to QCL Type-A.

In other implementations, a subset of reference signals (e.g., SDRSs) of the set of reference signals may be QCLed or have a spatial relation with one or more of a corresponding SRS or a corresponding DMRS for PUSCH with respect to Doppler shift, Doppler spread, and average delay and delay spread according to QCL Type-A. In some examples, the UE may support uplink transmissions configured with an SRS configuration. The SRS configuration may include a spatial Rx parameter includes a spatial-domain reference signal indicator. The UE may be expected to use a spatial transmit filter for the SRS that is based on a received filter used for receiving an SDRS corresponding to the SDRS indicator. Alternatively, the UE may support uplink transmissions configured with a PUCCH configuration. The SRS configuration may include a spatial Rx parameter includes a spatial-domain reference signal indicator. The UE may be expected to use a spatial transmit filter for a PUCCH transmission that is based on a received filter used for receiving an SDRS corresponding to the SDRS indicator.

In some implementations, each reference signal (e.g., SDRS) of the set of reference signals may be a TRS and may be QCLed with a corresponding SS/PBCH at least with respect to Doppler shift and average delay properties. In some examples, each reference signal may be QCLed with the corresponding SS/PBCH according to QCL Type-C. Additionally, the reference signal may be associated with a spatial Rx parameter according to QCL Type-D, the reference signal QCLed to the corresponding SS/PBCH or another reference signal such as a CSI-RS for beam management.

The reference signal configuration 1300 may support spatial hopping of reference signals (e.g., particularly for SpRSs). A reference signal (e.g., an SDRS) in the set of reference signals may be associated with a fixed subset of antenna ports. Alternatively, the reference signal may be associated with a different subset of antenna ports over multiple time units. One or more elements or features from one or more of the following described implementations may be combined.

In some implementations, the UE may be configured to receive a sequence (also referred to herein as a burst) of reference signals (e.g., an SDRS burst). In some examples, the NE may configure the sequence of reference signals to be received by the UE over consecutive slots. Alternatively, the NE may configure the sequence of reference signals to be received by the UE every m slots (e.g., m=2) and the reference signals to be received by the UE in alternating slots. In some cases, the reference signals may be periodic and the NE may configure the sequence of reference signals to be received by the UE according to a periodicity value associated with the reference signals.

In some implementations, the subset of antenna ports may vary across the sequence, such that a different subset of antenna ports may be associated with CSI-RSs at a given occasion of the sequence of reference signals (e.g., SDRSs). In an example, the subsets of antenna ports over two occasions of the sequency may differ by a value corresponding to a varying offset index of an antenna port added to a fixed subset of indices of antenna ports. In another example, the set of antenna ports may be partitioned into multiple, mutually exclusive groups of antenna ports, and a subset of antenna ports may be mapped to one or more groups of antenna ports such that two subsets of antenna ports over two occasions have a distinct mapping to the one or more groups of antenna ports. That is, the UE may receive the set of reference signals over multiple occasions in a sequence of slots in time, where an occasion of the sequence of slots in time may correspond to a distinct group of one or more symbols over at least one slot. In some examples, the subsets of antenna ports over the two occasions may be higher-layer configured. In some examples, the subsets of antenna ports over the two occasions may not be signaled to the UE.

In some implementations, the NE may configure the UE to measure a subset of the set of parameters (e.g., LSPs) based on the received sequence of reference signals (e.g., SDRSs). In some examples, the NE may configure the UE to measure the subset of parameters over each occasion of the sequency of reference signals. Alternatively, the NE may configure the UE to select an occasion of the sequence of reference signals in addition to a reference signal from the reference signals within the occasion of the sequence of reference signals.

The reference signal configuration 1300 illustrates example antenna arrays 1302, 1304, 1306, and 1308 of a set of reference signals corresponding to a set antenna ports (e.g., each reference signal/antenna port represented as “X”). The set of antenna ports may be partitioned into multiple subsets of antenna ports according to different types of parameters (e.g., LSPs), such as the parameters 1310-a, 1310-b, 1310-c, and 1310-d. As the antenna arrays 1302, 1304, 1306, and 1308 may correspond to XL MIMO antenna arrays, which may be large enough that the parameters may be variable across the antenna ports. For example, if the antenna size itself increased and if a UE gets closer to the antenna ports, some antenna ports may be blocked (e.g., affecting line-of-sight) or otherwise have different parameters. By utilizing the techniques described herein, the UE may measure parameters for each reference signal of a set of reference signals that correspond to multiple subsets of antenna arrays in each antenna array 1302, 1304, 1306, and 1308, and transmit a report indicating feedback information corresponding to the parameters. In this way, subsets of antenna ports may be identified and separately handled based on corresponding parameters 1310.

The reference signal configuration 1300 a CSI feedback framework for transmitting feedback information related to the parameters 1310 after performing receiving the set of reference signals and measuring the parameters 1310. The UE may report CSI feedback to the NE. The feedback may include measurements (or information corresponding to measurements) based on the received set of reference signals. One or more elements or features from one or more of the following described implementations may be combined.

In some implementations, the UE may report parameter (e.g., LSP) values corresponding to the set of reference signals (e.g., SDRSs) in a CSI report. In some examples, a reported parameter value may correspond to a parameter that is based on one or more of an RSRP value, an SINR value, a Doppler shift value, an average delay value, a time-domain correlation value, a Doppler-domain correlation value, a frequency-domain correlation value, a delay-domain correlation value, or a spatial-domain correlation value. In some cases, each reference signal of the set of reference signals may be associated with at least one parameter value of the reported parameter value (e.g., each reference signal/antenna port “X” of an antenna array 1302, 1304, 1306, or 1308 may be associated with at least one parameter value of a corresponding parameter 1310). In some examples, for two parameter values of a same type (e.g., two RSRP values), the UE may report a first of the two parameter values in a differential form with respect to a value of a second of the two parameter values. Put another way, the report may include at least two parameter values, where a first parameter value may be a differential value with respect to a value of a second parameter value (e.g., the differential form may indicate a difference between the first parameter value and the second parameter value). Alternatively, for two parameter values of a same type (e.g., two RSRP values), the UE may report a first of the two parameter values in a differential form with respect to an average of the two parameter values. Put another way, the report may include at least two parameter values, where a first parameter value may be a differential value with respect to an average of the first and second parameter values (e.g., the differential form may indicate a difference between the first parameter and the average of the first and second parameter values).

In some implementations, the CSI report may include reference signal resource indicators. That is, the UE may report an indication of a reference signal (e.g., SDRS) from the set of reference signals in the CSI report. In some cases, the indication of the reference signals may identify a subset of antenna ports that are featured with spatial-domain stationarity. In some examples, a ‘null’ or ‘invalid’ codepoint may be included within the indication of the reference signal, which may identify a case where at lest one of the entire set of antenna ports may be featured with spatial-domain stationarity or none of the subsets of antenna ports may be featured with spatial-domain stationarity.

In some examples, two antenna ports may have spatial-domain stationarity if at least one of a large-scale channel parameter (e.g., pathloss, shadow fading, delay, Doppler characteristics, RSRP, or SINR, among others) of the two antenna ports differ by no more than a threshold. The ME may configure the UE with the threshold by higher layer signaling. In some examples, antenna ports that exhibit spatial-domain stationarity may have the same QCL source reference signal for at least one of the QCL types (e.g., QCL Type-A, QCL Type-D). In some examples, the indication of the reference signal may correspond to at least one reference signal resource that may include a subset of antenna ports featured with spatial-domain stationarity. The NE may configure the UE with a set of reference signal resources and a set including a different combination of resources (e.g., individual reference signal resources, ‘null’ or ‘invalid’ combination), and the UE may report an indication of a reference signal that is selected from the configured set.

In some implementations, the NE may configure the UE with a sequence (e.g., burst) of reference signals (e.g., SDRSs). Accordingly, the UE may report a set of parameters based on the received sequence of reference signals (e.g., the UE may transmit a CSI report including parameters and a transmission occasion index for a sequence of reference signals). In some examples, the set of parameters may include a set of LSP values the UE measured over each occasion of the sequence of reference signals. The UE may calculate a differential value of a first LSP value corresponding to a first time occasion with respect to a second LSP value corresponding to a subsequent time occasion. In some examples, the set of parameters may include a selection of a time occasion of the sequence of reference signals in addition to a reference signal indication from the reference signals within the time occasion of the sequence of reference signals.

In some implementations, the UE may configure the CSI report with an aperiodic time-domain behavior. The UE may report the aperiodic CSI report over via PUSCH resources.

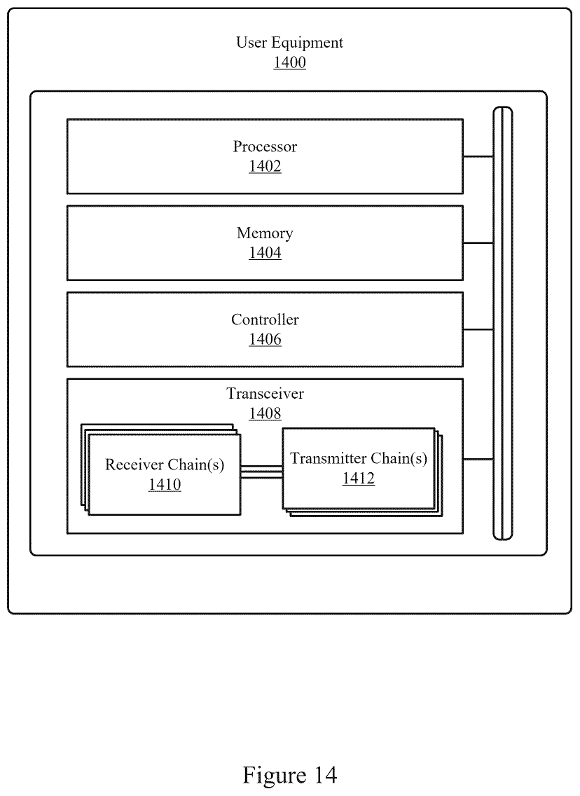

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein.

The UE 1400 may be configured to or operable to support a means for receiving a plurality of reference signals that correspond to a plurality of subsets of antenna ports of a set of antenna ports; measuring a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and an NE; and transmitting a report comprising feedback information corresponding to the set of parameters.

Additionally, the reference signal of the plurality of reference signals corresponds to a TRS. Additionally, or alternatively, the reference signal of the plurality of reference signals corresponds to a CSI-RS that is received via an NZP CSI-RS resource. Additionally, or alternatively, the reference signal of the plurality of reference signals corresponds to a CSI-RS received via multiple NZP CSI-RS resources over a same slot. Additionally, or alternatively, a reference signal of the plurality of reference signals corresponds to a CSI-RS received via two NZP CSI-RS resources, wherein each NZP CSI-RS resource is associated with a single port. Additionally, or alternatively, the set of parameters comprise at least one of a pathloss, a wideband channel gain, an RSRP, an SINR, a Doppler shift, an average delay, or a large-scale channel parameter. Additionally, or alternatively, the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

Additionally, the UE 1400 may be configured to support receiving the plurality of reference signals over multiple occasions in a sequence of slots in time, wherein an occasion of the sequence of slots in time corresponds to a distinct group of one or more symbols over at least one slot. Additionally, the UE 1400 may be configured to support measuring a subset of the set of parameters for the occasion of the sequence of slots. Additionally, the UE 1400 may be configured to support mapping the plurality of reference signals to the plurality of subsets of antenna ports for one or more occasions of the sequence of slots.

Additionally, the UE 1400 may be configured to support measuring one or more parameters for each occasion of the sequence of slots, wherein the feedback information corresponds to the one or more parameters. Additionally, the feedback information corresponds to at least one parameter for each reference signal of the plurality of reference signals; the plurality of reference signals comprising two reference signals, wherein the report includes a first of two parameter values in a differential form with respect to a value of a second of the two parameter values. Additionally, or alternatively, the report includes an indication of a reference signal from the plurality of reference signals. Additionally, or alternatively, the report is configured with a periodic time-domain behavior, and to transmit the report, the UE 1400 may be configured to support transmitting the report via a PUCCH.

Additionally, or alternatively, the UE 1400 may support at least one memory (e.g., the memory 1404) and at least one processor (e.g., the processor 1402) coupled with the at least one memory and configured to cause the UE 1400 to: receive a plurality of reference signals that correspond to a plurality of subsets of antenna ports of a set of antenna ports; measure a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE 1400 and an NE; and transmit a report comprising feedback information corresponding to the set of parameters.

Additionally, the reference signal of the plurality of reference signals corresponds to a TRS. Additionally, or alternatively, the reference signal of the plurality of reference signals corresponds to a CSI-RS that is received via an NZP CSI-RS resource. Additionally, or alternatively, the reference signal of the plurality of reference signals corresponds to a CSI-RS received via multiple NZP CSI-RS resources over a same slot. Additionally, or alternatively, a reference signal of the plurality of reference signals corresponds to a CSI-RS received via two NZP CSI-RS resources, wherein each NZP CSI-RS resource is associated with a single port. Additionally, or alternatively, the set of parameters comprise at least one of a pathloss, a wideband channel gain, an RSRP, an SINR, a Doppler shift, an average delay, or a large-scale channel parameter. Additionally, or alternatively, the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

Additionally, the UE 1400 may be configured to support the at least one processor configured to receive the plurality of reference signals over multiple occasions in a sequence of slots in time, wherein an occasion of the sequence of slots in time corresponds to a distinct group of one or more symbols over at least one slot. Additionally, the UE 1400 may be configured to support the at least one processor configured to measure a subset of the set of parameters for the occasion of the sequence of slots. Additionally, the UE 1400 may be configured to support the at least one processor configured to map the plurality of reference signals to the plurality of subsets of antenna ports for one or more occasions of the sequence of slots.

Additionally, the UE 1400 may be configured to support the at least one processor configured to measure one or more parameters for each occasion of the sequence of slots, wherein the feedback information corresponds to the one or more parameters. Additionally, the feedback information corresponds to at least one parameter for each reference signal of the plurality of reference signals; the plurality of reference signals comprising two reference signals, wherein the report includes a first of two parameter values in a differential form with respect to a value of a second of the two parameter values. Additionally, or alternatively, the report includes an indication of a reference signal from the plurality of reference signals. Additionally, or alternatively, the report is configured with a periodic time-domain behavior, and to transmit the report, the UE 1400 may be configured to support the at least one processor configured to transmit the report via a PUCCH.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

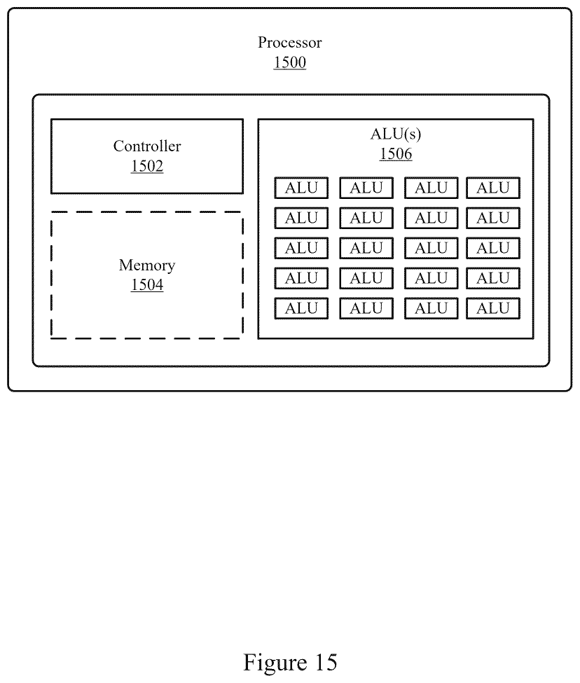

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein.

The processor 1500 may be configured to or operable to support at least one controller (e.g., the controller 1502) coupled with at least one memory (e.g., the memory 1504) and configured to cause the processor to receive a plurality of reference signals that correspond to a plurality of subsets of antenna ports of a set of antenna ports; measure a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and an NE; and transmit a report comprising feedback information corresponding to the set of parameters.

Additionally, the reference signal of the plurality of reference signals corresponds to a TRS. Additionally, or alternatively, the reference signal of the plurality of reference signals corresponds to a CSI-RS that is received via an NZP CSI-RS resource. Additionally, or alternatively, the reference signal of the plurality of reference signals corresponds to a CSI-RS received via multiple NZP CSI-RS resources over a same slot. Additionally, or alternatively, a reference signal of the plurality of reference signals corresponds to a CSI-RS received via two NZP CSI-RS resources, wherein each NZP CSI-RS resource is associated with a single port. Additionally, or alternatively, the set of parameters comprise at least one of a pathloss, a wideband channel gain, an RSRP, an SINR, a Doppler shift, an average delay, or a large-scale channel parameter. Additionally, or alternatively, the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

Additionally, the processor 1500 may be configured to or operable to receive the plurality of reference signals over multiple occasions in a sequence of slots in time, wherein an occasion of the sequence of slots in time corresponds to a distinct group of one or more symbols over at least one slot. Additionally, the processor 1500 may be configured to or operable to measure a subset of the set of parameters for the occasion of the sequence of slots. Additionally, the processor 1500 may be configured to or operable to map the plurality of reference signals to the plurality of subsets of antenna ports for one or more occasions of the sequence of slots.

Additionally, the processor 1500 may be configured to or operable to measure one or more parameters for each occasion of the sequence of slots, wherein the feedback information corresponds to the one or more parameters. Additionally, the feedback information corresponds to at least one parameter for each reference signal of the plurality of reference signals; the plurality of reference signals comprising two reference signals, wherein the report includes a first of two parameter values in a differential form with respect to a value of a second of the two parameter values. Additionally, or alternatively, the report includes an indication of a reference signal from the plurality of reference signals. Additionally, or alternatively, the report is configured with a periodic time-domain behavior, and to transmit the report, the processor 1500 may be configured to or operable to transmit the report via a PUCCH.

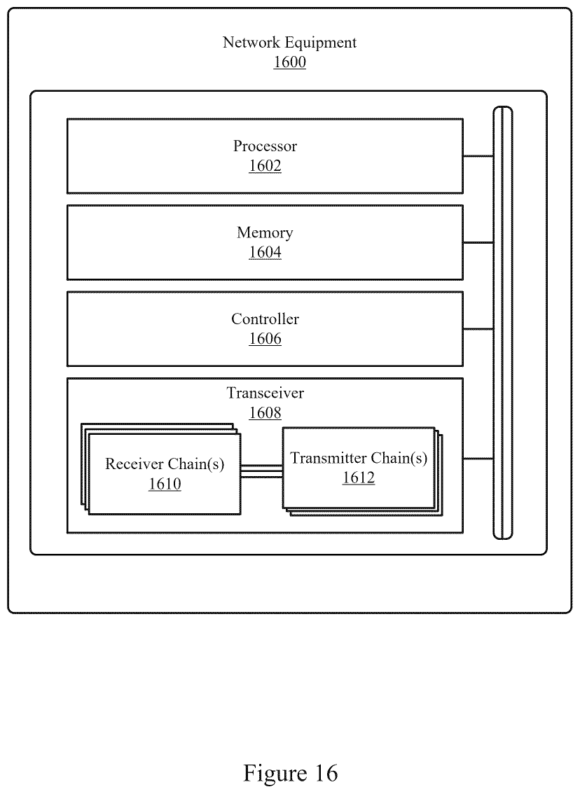

FIG. 16 illustrates an example of an NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein.

The NE 1600 may be configured to or operable to support a means for transmitting a plurality of reference signals that correspond to a plurality of subsets of antenna ports of a set of antenna ports; and receiving a report comprising feedback information corresponding to a set of parameters based at least in part on the plurality of reference signals, wherein the set of parameters corresponds to different subsets of antenna ports of the plurality of subsets of antenna ports, and wherein the different subsets of antenna ports are associated with a wireless channel between a UE and the NE 1600.

Additionally, the reference signal of the plurality of reference signals corresponds to a TRS. Additionally, or alternatively, the reference signal of the plurality of reference signals corresponds to a CSI-RS that is transmitted via an NZP CSI-RS resource. Additionally, or alternatively, the reference signal of the plurality of reference signals corresponds to a CSI-RS transmitted via multiple NZP CSI-RS resources over a same slot. Additionally, or alternatively, a reference signal of the plurality of reference signals corresponds to a CSI-RS transmitted via two NZP CSI-RS resources, wherein each NZP CSI-RS resource is associated with a single port. Additionally, or alternatively, the set of parameters comprise at least one of a pathloss, a wideband channel gain, an RSRP, an SINR, a Doppler shift, an average delay, or a large-scale channel parameter. Additionally, or alternatively, the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

Additionally, the NE 1600 may be configured to support transmitting the plurality of reference signals over multiple occasions in a sequence of slots in time, wherein an occasion of the sequence of slots in time corresponds to a distinct group of one or more symbols over at least one slot. Additionally, the plurality of reference signals is mapped to the plurality of subsets of antenna ports for one or more occasions of the sequence of slots.

Additionally, or alternatively, the feedback information corresponds to the one or more parameters. Additionally, or alternatively, the feedback information corresponds to at least one parameter for each reference signal of the plurality of reference signals; the plurality of reference signals comprising two reference signals, wherein the report includes a first of two parameter values in a differential form with respect to a value of a second of the two parameter values. Additionally, or alternatively, the report includes an indication of a reference signal from the plurality of reference signals. Additionally, or alternatively, the report is configured with a periodic time-domain behavior, and to transmit the report, the NE 1600 may be configured to support receiving the report via a PUCCH.

Additionally, or alternatively, the NE 1600 may support at least one memory (e.g., the memory 1604) and at least one processor (e.g., the processor 1602) coupled with the at least one memory and configured to cause the NE 1600 to: transmit a plurality of reference signals that correspond to a plurality of subsets of antenna ports of a set of antenna ports; and receive a report comprising feedback information corresponding to a set of parameters based at least in part on the plurality of reference signals, wherein the set of parameters corresponds to different subsets of antenna ports of the plurality of subsets of antenna ports, and wherein the different subsets of antenna ports are associated with a wireless channel between a UE and the NE 1600.

Additionally, the reference signal of the plurality of reference signals corresponds to a TRS. Additionally, or alternatively, the reference signal of the plurality of reference signals corresponds to a CSI-RS that is transmitted via an NZP CSI-RS resource. Additionally, or alternatively, the reference signal of the plurality of reference signals corresponds to a CSI-RS transmitted via multiple NZP CSI-RS resources over a same slot. Additionally, or alternatively, a reference signal of the plurality of reference signals corresponds to a CSI-RS transmitted via two NZP CSI-RS resources, wherein each NZP CSI-RS resource is associated with a single port. Additionally, or alternatively, the set of parameters comprise at least one of a pathloss, a wideband channel gain, an RSRP, an SINR, a Doppler shift, an average delay, or a large-scale channel parameter. Additionally, or alternatively, the plurality of reference signals is QCLed with at least one of an SS/PBCH, a TRS, or a CSI-RS, wherein the SS/PBCH, the TRS, and the CSI-RS are configured with Doppler shift properties, Doppler spread properties, or both.

Additionally, or alternatively, a subset of reference signals of the plurality of reference signals is QCLed with at least one of a CSI-RS associated with a repetition parameter or a TRS parameter, or a DMRS associated with at least one of a PDSCH or a PDCCH, according to at least one of a Doppler shift, a Doppler spread, an average delay, or a delay spread. Additionally, or alternatively, a subset of reference signals of the plurality of reference signals is QCLed with an SRS, a DMRS associated with a PUCCH, or both according to at least one of a Doppler shift, a Doppler spread, an average delay, or a delay spread, wherein the SRS is associated with a spatial transmit filter.

Additionally, the NE 1600 may be configured to support the at least one processor configured to transmit the plurality of reference signals over multiple occasions in a sequence of slots in time, wherein an occasion of the sequence of slots in time corresponds to a distinct group of one or more symbols over at least one slot. Additionally, the plurality of reference signals is mapped to the plurality of subsets of antenna ports for one or more occasions of the sequence of slots.

Additionally, or alternatively, the feedback information corresponds to the one or more parameters. Additionally, or alternatively, the feedback information corresponds to at least one parameter for each reference signal of the plurality of reference signals; the plurality of reference signals comprising two reference signals, wherein the report includes a first of two parameter values in a differential form with respect to a value of a second of the two parameter values. Additionally, or alternatively, the report includes an indication of a reference signal from the plurality of reference signals. Additionally, or alternatively, the report is configured with a periodic time-domain behavior, and to transmit the report, the NE 1600 may be configured to support the at least one processor configured to receive the report via a PUSCH.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

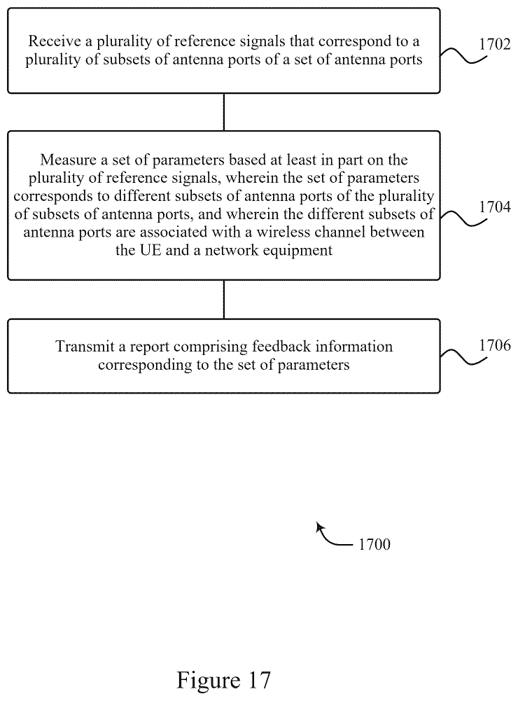

FIG. 17 illustrates a flowchart of a method 1700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1702, the method may include receiving a set of multiple reference signals that correspond to multiple subsets of antenna ports of a set of antenna ports. A reference signal of the may correspond to a TRS, a CSI-RS that is transmitted via an NPZ CSI-RS resource, or a CSI-RS transmitted via multiple NZP CSI-RS resources over a same slot. The operations of 1702 may be performed in accordance with examples as described herein. In some implementations, aspects of the operations of 1702 may be performed by a UE as described with reference to FIG. 14.

At 1704, the method may include measuring a set of parameters based on the set of multiple reference signals, where the set of parameters may correspond to different subsets of antenna ports, and where the different subsets of antenna ports may be associated with a wireless channel between a UE and an NE. The set of parameters may comprise at least one of a pathloss, a wideband channel gain, an RSRP, an SINR, a Doppler shift, an average delay, or a large-scale channel parameter. In some implementations, aspects of the operations of 1704 may be performed by a UE as described with reference to FIG. 14.

At 1706, the method may include transmitting a report comprising feedback information corresponding to the set of parameters. In some examples, the report may comprise feedback information corresponding to at least one parameter for each reference signal of the set of multiple reference signals. Additionally, or alternatively, the report may include an indication of a reference signal from the set of multiple reference signals. In some implementations, aspects of the operations of 1706 may be performed by a UE as described with reference to FIG. 14.

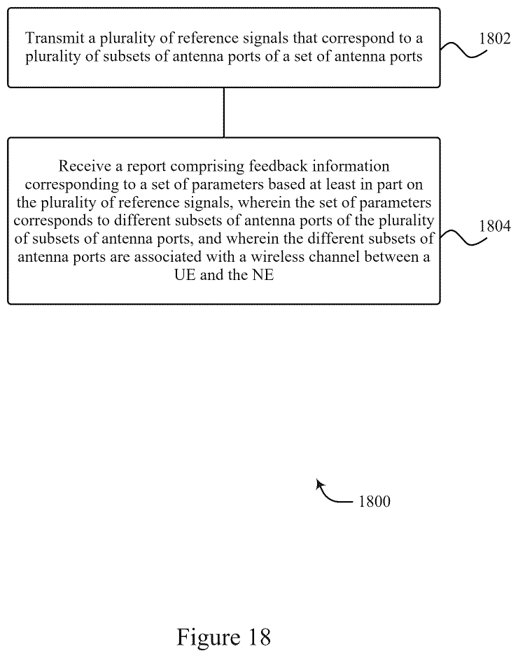

FIG. 18 illustrates a flowchart of a method 1800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1802, the method may include transmitting a set of multiple reference signals that correspond to multiple subsets of antenna ports of a set of antenna ports. A reference signal of the may correspond to a TRS, a CSI-RS that is transmitted via an NPZ CSI-RS resource, or a CSI-RS transmitted via multiple NZP CSI-RS resources over a same slot. In some implementations, aspects of the operations of 1802 may be performed by a UE as described with reference to FIG. 16.

At 1804, the method may include receiving a report comprising feedback information corresponding to a set of parameters based on the set of multiple reference signals, where the set of parameters may correspond to different subsets of antenna ports, and where the different subsets of antenna ports are associated with a wireless channel between a UE and the NE. In some implementations, aspects of the operations of 1804 may be performed by a UE as described with reference to FIG. 16.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a plurality of reference signals that correspond to a plurality of subsets of antenna ports of a set of antenna ports;
measure a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and a network equipment; and
transmit a report comprising feedback information corresponding to the set of parameters.

2. The UE of claim 1, wherein a reference signal of the plurality of reference signals corresponds to a tracking reference signal (TRS).

3. The UE of claim 1, wherein a reference signal of the plurality of reference signals corresponds to a channel state information reference signal (CSI-RS) that is received via a non-zero power (NZP) CSI-RS resource.

4. The UE of claim 1, wherein a reference signal of the plurality of reference signals corresponds to a channel state information reference signal (CSI-RS) received via multiple non-zero power (NZP) CSI-RS resources over a same slot.

5. The UE of claim 1, wherein a reference signal of the plurality of reference signals corresponds to a channel state information reference signal (CSI-RS) received via two non-zero power (NZP) CSI-RS resources, and wherein each NZP CSI-RS resource is associated with a single port.

6. The UE of claim 1, wherein the set of parameters comprises at least one of a pathloss, a wideband channel gain, a reference signal received power (RSRP), a signal-to-interference-and-noise ratio (SINR), a Doppler shift, an average delay, or a large-scale channel parameter.

7. The UE of claim 1, wherein the plurality of reference signals is quasi-collocated (QCLed) with at least one of a synchronized signal/physical broadcast channel (SS/PBCH), a tracking reference signal (TRS), or a channel state information reference signal (CSI-RS), wherein the SS/PBCH, the TRS, and the CSI-RS are configured with Doppler shift properties, Doppler spread properties, or both.

8. The UE of claim 1, wherein a subset of reference signals of the plurality of reference signals is quasi-collocated (QCLed) with at least one of a channel state information reference signal (CSI-RS) associated with a repetition parameter or a tracking reference signal (TRS) parameter, or a demodulation reference signal (DMRS) associated with at least one of a physical downlink shared channel (PDSCH) or a physical downlink control channel (PDCCH), according to at least one of a Doppler shift, a Doppler spread, an average delay, or a delay spread.

9. The UE of claim 1, wherein a subset of reference signals of the plurality of reference signals is quasi-collocated (QCLed) with a sounding reference signal (SRS), a demodulation reference signal (DMRS) associated with a physical uplink shared channel (PUSCH), or both according to at least one of a Doppler shift, a Doppler spread, an average delay, or a delay spread, wherein the SRS is associated with a spatial transmit filter.

10. The UE of claim 1, wherein the at least one processor is configured to cause the UE to receive the plurality of reference signals over multiple occasions in a sequence of slots in time, wherein an occasion of the sequence of slots in time corresponds to a distinct group of one or more symbols over at least one slot.

11. The UE of claim 10, wherein the at least one processor is configured to cause the UE to measure a subset of the set of parameters for the occasion of the sequence of slots.

12. The UE of claim 10, wherein the at least one processor is configured to cause the UE to map the plurality of reference signals to the plurality of subsets of antenna ports for one or more occasions of the sequence of slots.

13. The UE of claim 10, wherein, to measure the set of parameters, the at least one processor is configured to cause the UE to measure one or more parameters for each occasion of the sequence of slots, wherein the feedback information corresponds to the one or more parameters.

14. The UE of claim 1, wherein the feedback information corresponds to at least one parameter for each reference signal of the plurality of reference signals.

15. The UE of claim 14, wherein the plurality of reference signals comprises two reference signals, and wherein the report includes a first of two parameter values in a differential form with respect to a value of a second of the two parameter values.

16. The UE of claim 1, wherein the report includes an indication of a reference signal from the plurality of reference signals.

17. The UE of claim 1, wherein the report is configured with a periodic time-domain behavior, and wherein to transmit the report, the at least one processor is configured to cause the UE to transmit the report via a physical uplink shared channel (PUSCH).

18. A processor for wireless communication, comprising:
at least one controller coupled with at least one memory and configured to cause the processor to:
receive a plurality of reference signals that correspond to a plurality of subsets of antenna ports of a set of antenna ports;
measure a set of parameters based at least in part on the plurality of reference signals, wherein the set of parameters corresponds to different subsets of antenna ports of the plurality of subsets of antenna ports, and wherein the different subsets of antenna ports are associated with a wireless channel between a user equipment (UE) and a network equipment (NE); and
transmit a report comprising feedback information corresponding to the set of parameters.

19. A network entity (NE) for wireless communication, comprising:
at least one memory; and
at least one processor coupled with the at least one memory and configured to cause the NE to:
transmit a plurality of reference signals that correspond to a plurality of subsets of antenna ports of a set of antenna ports; and
receive a report comprising feedback information corresponding to a set of parameters based at least in part on the plurality of reference signals, wherein the set of parameters corresponds to different subsets of antenna ports of the plurality of subsets of antenna ports, and wherein the different subsets of antenna ports are associated with a wireless channel between a user equipment (UE) and the NE.

20. A method performed by a user equipment (UE), the method comprising:
receiving a plurality of reference signals that correspond to a plurality of subsets of antenna ports of a set of antenna ports;
measuring a set of parameters based at least in part on the plurality of reference signals, wherein the set of parameters corresponds to different subsets of antenna ports of the plurality of subsets of antenna ports, and wherein the different subsets of antenna ports are associated with a wireless channel between the UE and a network equipment (NE); and
transmitting a report comprising feedback information corresponding to the set of parameters.
